(19) United States
(12) Patent Application Publication
(10) Pub. No.: US 2009/0213523 A1
(43) Pub. Date: Aug. 27, 2009

(54) Selectable size AC motor run capacitor

(75) Inventor: John L. Slaughter, Louisville, KY (US)

Correspondence Address: H. JAY SPIEGEL - H. JAY SPIEGEL & ASSOCIATES, P.O. BOX 11, MOUNT VERNON, VA, 22121, US

(73) Assignee: JLAS Properties, LLC

(21) Appl. No.: 12/320,090

(22) Filed: Jan. 16, 2009

Related U.S. Application Data
(60) Provisional application No. 61/065,111, filed on Feb. 8, 2008.

(51) Int. Cl. H01G 5/011

(52) U.S. Cl. 361/278

(57) ABSTRACT

The present invention relates to a capacitor unit for use as a run capacitor in an AC motor circuit including a grouping of two to ten capacitors connected to an integral and internal multiple position selector switch having an externally accessible atuator knob in such a way that different selector switch positions select different parallel combinations of the capacitors. The capacitors are of suitable size and electrical characteristics for use as run capacitors in an AC motor circuit and a grouping of one of the two leads of each capacitor in the group is interconnected to form a first output lead for the capacitance unit. The selector switch is usable in an AC motor circuit for switching capacitors in and out of a parallel group in which the free leads of each of the capacitors are individually connected to terminals on the selector switch and the common terminal on the selector switch provides a second output lead for the capacitor unit, the selector switch being capable of connecting various combinations of the capacitors in a parallel configuration such that the capacitor unit yields selectable capacitance values. A housing to package the capacitors, the selector switch, and the required wiring is included.

### BACKGROUND OF THE INVENTION

The present invention relates to the field of AC motors typically in the voltage range of 110 to 440 VAC that require a ‘run’ capacitor to change the phase relationship between the windings and therefore cause the motor to run. Priority is claimed from Provisional application Ser. No. 61/065,111, filed Feb. 8, 2008.

“Run” capacitors are available in supply houses all over the country. The vast majority of these are single capacitance rated capacitors and therefore work in only limited and specific situations. When repairing a given motor circuit, current practice is to identify the failed capacitor, determine the size, voltage rating, current rating and capacitance rating and then order a replacement part.

Capacitor units with multiple capacitors internal to the unit are known in the art and are described in U.S. Pat. No. 4,028,595 to Stockman for MULTI-VOLTAGE CAPACITOR SECTION issued on Jun. 7, 1977. This patent teaches the making of a capacitor with multiple independent metalized films separated by dielectric sheets wound around a common core with leads connected to each sheet. The leads are then organized in pairs resulting in one capacitor per pair of leads. Such a capacitor package is sold under the label of TURBO 200 and manufactured by AMRAD ENGINEERING, INC. in Palm Coast, Fla., for sale to the public. Many capacitors can be incorporated into one package using this technique. These internal capacitors are selected or grouped using external jumpers to connect the desired capacitors in parallel and then are connected into the motor circuit. This is facilitated by the manufacturers supplying a multi-page electrical schematic which is difficult to decipher by the average consumer. The present invention differs from the teachings of the prior art including the TURBO 200 capacitor package by providing an integral internal switching mechanism allowing the user to selectively choose the desired capacitance from amongst numerous choices.

U.S. Pat. No. 7,067,869 to Cheng et al. for ADJUSTABLE 3D CAPACITOR, that issued on Jun. 27, 2006, teaches many electronic capacitors adjacently integrated into a microchip and are selectable in the circuit using electronic switches (transistors, FET's or the like). Using these electronic switches, any combination from one to all of the capacitors may be switched into a parallel group and depending on which capacitors are selected, thus allowing many discrete values of capacitance.

### SUMMARY OF THE INVENTION

The present invention provides a capacitor unit which is the correct physical size for most needs and where the correct capacitance rating can be attained by simply moving a selector switch integral to the unit to the proper position to give the desired rating.

The present invention overcomes the shortcomings of the prior art by providing a capacitor unit that can be used in a multitude of situations where a replacement “run” capacitor of the correct physical size and capacitance rating is required. One or two of these units can be stocked in a repairman's vehicle or even tool box, whereupon the replacement is immediately available instead of perhaps hours to days or weeks away. Stocking of several sizes of capacitors becomes unnecessary. Enormous savings in time and money are possible.

A device is disclosed herein that can be used as (1) a replacement for or (2) original equipment in an AC motor circuit for which a “run” capacitor is required to change the phase of the windings and thus cause the motor to run. When the capacitor fails, the motor won't run. The correct physical size capacitor is, of course, required; and there are many sizes. More importantly, however, is the fact that capacitor with the correct “capacitance” (microfarad rating) and correct voltage and current characteristics is used for a given motor circuit. The present invention provides a capacitor unit which is of a common physical size and has a selector switch, or the like, allowing the user to easily adjust the capacitor unit to provide whatever capacitance rating is required without the use of jumpers or special tools of any kind. In the present invention, a selected number of capacitors are chosen to be incorporated into the capacitor unit. The capacitors can be type individual “can” type capacitors or they can be manufactured as individual capacitors wrapped around one common core.

Sometimes, two motors are in close proximity to one another. The outdoor unit in an HVAC unit is an example. In this example, the motors are the compressor motor and the fan motor. Both of these motors require run capacitors. A variant of the above described capacitance unit comprises a two pole selector switch and thus provides two separate capacitors of the desired size for each motor, selected by the selector switch.

The present invention discloses a capacitor unit for use as a run capacitor in an AC motor circuit including a grouping of two to ten capacitors connected to a multiple position selector switch in such a way that different selector switch positions select different parallel combinations of the capacitors. The grouping of two to ten capacitors is of suitable size and electrical characteristics for use as run capacitors in an AC motor circuit, wherein grouping one of the two leads of each capacitor in the group is interconnected to form a first output lead for the capacitance unit. The selector switch is of suitable size and electrical characteristics for use in an AC motor circuit for switching capacitors in and out of a parallel group, wherein the free leads of each of the capacitors are individually connected to terminals on the selector switch and the common terminal on the selector switch provides a second output lead for the capacitance unit, the selector switch being capable of connecting various combinations of the capacitors in a parallel configuration such that the capacitor unit yields selectable capacitance values. A housing to package the capacitors, the selector switch and the wiring is included.

The capacitors used can comprise metallic film sheets separated by dielectric sheets wound around a common core and connected by leads. On the other hand, the capacitors can be conventional-type individual capacitors. The selector switch can use either “dry” contacts or electronic type switching devices such as triacs.

### BRIEF DESCRIPTION OF THE DRAWINGS

FIG. 1 is a perspective view showing three capacitors in a common unit which are wound around a common core. The leads are also shown.

FIG. 2 is a schematic showing the internal wiring of a 16 position selector switch.

FIG. 3 is a perspective view of 5 individual capacitors with leads.

FIG. 4 is a schematic view showing an electrical circuit including a 16 position selector switch and 5 capacitors connected to provide a capacitor unit as disclosed in the present invention.

FIG. 5 is a perspective view of a complete capacitor unit integrated into a cylindrical housing and including a capacitance selector switch.

FIG. 6 is a perspective view similar to that of FIG. 5, but with an alternative selector switch.

### SPECIFIC DESCRIPTION OF THE PREFERRED EMBODIMENTS

In accordance with the present invention, there is provided a device which is a multiply adjustable “run” capacitor for AC motor circuits.

An example is presented in the drawings, wherein five capacitors of varying sizes are chosen. The common leads of each of the capacitors are connected together to form the first lead of the “capacitor unit.” Each of the other five leads are connected to the five terminals of a 16 position selector switch. Such a selector switch is well known in the art. Another lead is connected to the common terminal of the selector switch to form the second lead of the “capacitor unit.” Internally, the switch will give 16 different parallel combinations of the 5 capacitors and thus, 16 different capacitance ratings possible from this one capacitor unit.

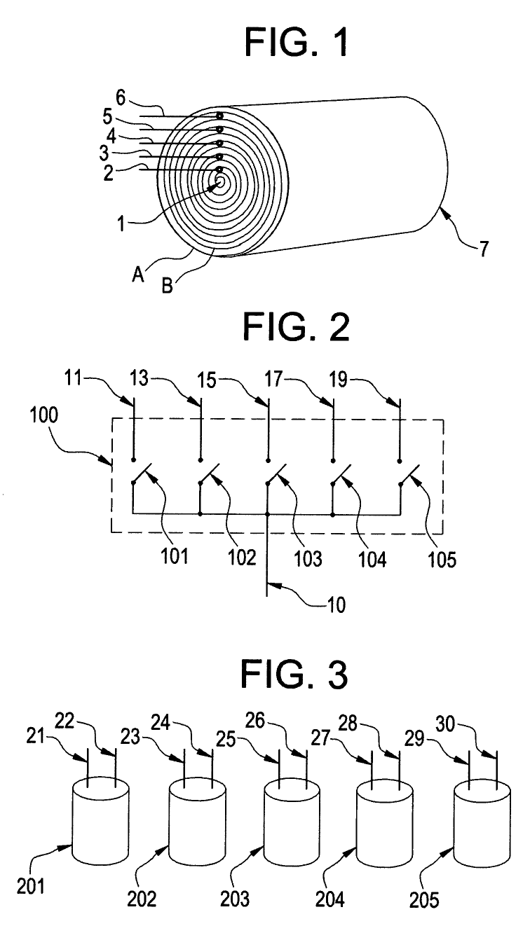

With reference to FIG. 1, a multiple capacitor grouping 7 is depicted, wherein metallic film sheets A are separated by dielectric sheets B, and are wound around a common core. Three capacitors are provided therein with their respective leads 1 and 2, leads 3 and 4, and leads 5 and 6. However, many more capacitors could be incorporated simply by rolling more metallic film sheets and dielectric sheets around the given unit.

FIG. 2 is a schematic representation of a selector switch 100 that is usable in conjunction with a capacitor grouping 7. Not shown is the movement within the switch housing that opens and closes switches 101 through 105 to yield the different combinations of 5 capacitors (as an example) to yield the desired final capacitance value. An example of a typical rotary switch is the 32 position Alcoswitch Part No. 436287-1 available from Tyco Electronics Corporation, 1050 Westlakes Drive, Berwyn, Pa. 19312 and viewable at the following website: http://www.tycoelectronics.com/industry/appliance/pdf/catalogs/1308390_Sec_G_Rotary_Swi tches.pdf. Wasp Switches (Wessex Advanced Switching Products LTD) of Southmoor Lane, Havant Hampshire, UK, P09 IJW provides switches of this type made to one's order.

The switch depicted in FIG. 2 is of the dry contact type. An alternative embodiment can use electronic components such as triacs or the like as switches.

Five individual can-type capacitors usable with selector switch 100 instead of capacitor grouping 7 are shown in FIG. 3. This embodiment performs equally well as does capacitor grouping 7, but does not afford as small a package.

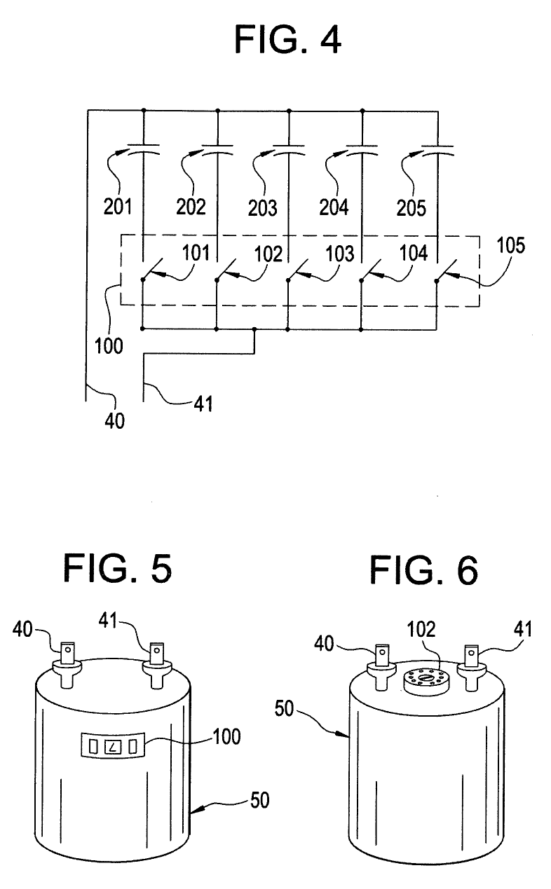

FIG. 4 is a schematic representation of a combination of a capacitor grouping 7 connected with a selector switch 100. Typical capacitance values in microfarads (or uF) for the five capacitors are as follows: capacitor 201 is 2.5 uF; capacitor 202 is 5 uF; capacitor 203 is 10 uF; capacitor 204 is 20 uF; and capacitor 205 is 40 uF.

Different switch combinations of this circuit would allow any final capacitance value from 2.5 uF to 77.5 uF in steps of 2.5 uF. As an example, closing switches 101, 103 and 105 would yield 2.5+10+40=52.5 uF. Thus, it can be seen that such a unit made up of capacitors and switches can easily be stocked and replaces any capacitor within the range of 2.5 to 77.5 uF. This arrangement yields up to 31 different capacitances. The switch 100 can be a 16 position switch, wherein the most typical capacitances are selected by those 16 positions. Other embodiments may employ a 10 position switch, for example, or any number of positions from 2 through 31, thus allowing whatever number of combinations of capacitors is desired by the manufacturer.

The package displayed in FIG. 5 is a cylindrical unit 50 that contains the capacitor grouping 7 and necessary wiring within and the selector switch 100 integral with the outside wall of the cylindrical unit 50. Any style of selector switch can be used, whether a rotary switch, push button switch, or any equivalents, so long as it can provide the necessary switch combinations, handle the current load and be integrated into a suitable package (as relates to size and shape). FIG. 6 shows an alternative in which a rotary switch 102 is mounted on top of the unit 50 between terminals 40 and 41.

Other embodiments of the present invention can comprise any number of capacitors and a selector switch with as many positions as required to achieve whatever number of capacitance levels might be desired.

A typical voltage range for capacitors discussed above is 110 to 440 VAC. However, this configuration could be used in ranges under 1 volt and up to thousands of volts. Additionally, the disclosed device will function in DC as well as AC circuitry. Examples of suitable ranges include 1 to 115 VAC, 115 to 440 VAC, 440 to 1000 VAC, 1 to 50 VDC, 50 to 600 UDC, and 600 to 1000 VDC.

The foregoing detailed description is given primarily for clearness of understanding and no unnecessary limitations are to be understood therefrom, for modification will become obvious to those skilled in the art upon reading this disclosure and maybe made without departing from the spirit of the invention and scope of the appended claims. Accordingly, this invention is not intended to be limited by the specific exemplification presented herein above. Rather, what is intended to be covered is within the spirit and scope of the appended claims.

1. A capacitor unit for use as a run capacitor in an AC motor circuit comprising:
a grouping of at least two capacitors of suitable size and electrical characteristics for use as run capacitors in an AC motor circuit, wherein one of two leads of each capacitor in the grouping are interconnected to form a first output lead for said capacitor unit;
a selector switch for use in an AC motor circuit for switching capacitors in and out of a parallel group, wherein free leads of each of said capacitors are interconnected to respective terminals on said selector switch, and a common terminal on said selector switch provides a second output lead for said capacitor unit, said selector switch selectively connecting various combinations of said capacitors in a parallel configuration such that said capacitor unit yields selectable capacitance values;
wiring connecting said capacitors, said selector switch, and terminals to yield said parallel configuration; and
a housing containing said capacitors, said selector switch and said wiring.

2. The capacitor unit defined in claim 1, wherein said capacitors within said grouping comprise metallic film sheets separated by dielectric sheets wound around a common core and interconnected by leads.

3. The capacitor unit defined in claim 2, wherein said selector switch comprises dry-type contacts for switching said capacitors in and out of said parallel configuration.

4. The capacitor unit defined in claim 2, wherein said selector switch comprises electronic type switches for switching said capacitors in and out of said parallel configuration.

5. The capacitor unit defined in claim 1, wherein said capacitors within said grouping comprise individual can-type capacitors connected by leads.

6. The capacitor unit defined in claim 5, wherein said selector switch comprises dry-type contacts for switching said capacitors in and out of said parallel configuration.

7. The capacitor unit defined in claim 5, wherein said selector switch comprises electronic type switches for switching said capacitors in and out of said parallel configuration.

8. The capacitor unit defined in claim 3, wherein said capacitors in said capacitor unit are rated for the voltage ranges selected from the group consisting of 1 to 115 VAC, 115 to 440 VAC, 440 to 1000 VAC, 1 to 50 VDC, 50 to 600 VDC, and 600 to 1000 VDC.

9. The capacitor unit defined in claim 4, wherein said capacitors in said capacitor unit are rated for the voltage ranges selected from the group consisting of 1 to 115 VAC, 115 to 440 VAC, 440 to 1000 VAC, 1 to 50 VDC, 50 to 600 VDC, and 600 to 1000 VDC.

10. The capacitor unit defined in claim 6, wherein said capacitors in said capacitor unit are rated for the voltage ranges selected from the group consisting of 1 to 115 VAC, 115 to 440 VAC, 440 to 1000 VAC, 1 to 50 VDC, 50 to 600 VDC, and 600 to 1000 VDC.

11. The capacitor unit defined in claim 7, wherein said capacitors in said capacitor unit are rated for the voltage ranges selected from the group consisting of 1 to 115 VAC, 115 to 440 VAC, 440 to 1000 VAC, 1 to 50 VDC, 50 to 600 VDC, and 600 to 1000 VDC.

12. The capacitor unit defined in claim 1, wherein said grouping of capacitors includes 2-10 capacitors.

13. The capacitor unit defined in claim 1, wherein said selector switch is mounted on a side wall of said housing.

14. The capacitor unit defined in claim 1, wherein said selector switch is mounted on a top wall of said housing.
